(19) United States
(12) Patent Application Publication
(10) Pub. No.: US 2018/0260421 A1
(43) Pub. Date: Sep. 13, 2018

(54) Provisionally Updating and Evaluating a Database Schema

(71) Applicant: CA, Inc., New York, NY (US)

(72) Inventor: Preetdeep Kumar, Hyderabad (IN)

(21) Appl. No.: 15/455,277

(22) Filed: Mar. 10, 2017

(51) Int. Cl. G06F 17/30

(52) U.S. Cl. CPC G06F 17/30294; G06F 17/30979; G06F 17/30345

(57) ABSTRACT

A computing device identifies a table of a relational database from a relational database query that references the table. The computing device provisionally updates a full schema of a non-relational database with a partial schema that describes the table pending evaluation of the full schema. The computing device accepts or rejects the provisional updating of the full schema according to the partial schema responsive to the evaluation of the full schema.

### BACKGROUND

The present disclosure relates to provisionally updating and evaluating a database schema, and more particularly to a computing device that provisionally updates a full schema of a non-relational database with a partial schema that describes a table of a relational database pending evaluation of the full schema.

A database schema specifies the organization of information stored within the database. Relational databases are typically organized as a series of related tables in which a table has a primary key that uniquely identifies the records of the table, and refers to the records of another table using a foreign key (i.e., a field that references the primary key of the other table).

Non-relational databases (e.g., document-based NoSQL databases) are typically structured differently than their relational database counterparts. In particular, non-relational databases generally tend to store information in records containing numerous name/value pairs. In some implementations, this allows all information pertaining to a particular item of significance to be found in one place within the non-relational database.

For example, in a non-relational database of customer data, each customer may have an entry with a name/value pair for each piece of information relating to that customer within that database, (e.g., contact information, transactions, etc.). In contrast, a corresponding relational database of that same customer data would typically use a table of customer names, a table of customer addresses, and a table of transactions, with each table including primary and foreign keys to indicate which customer is related to which addresses and/or transactions.

### BRIEF SUMMARY

The present disclosure provides methods, apparatus, systems, and non-transitory computer readable mediums storing computer program products. In particular, one or more embodiments include a method implemented by a computing device. The method comprises identifying a table of a relational database from a relational database query that references the table, provisionally updating a full schema of a non-relational database with a partial schema that describes the table pending evaluation of the full schema, and accepting or rejecting the provisional updating of the full schema according to the partial schema responsive to the evaluation of the full schema.

Other embodiments include a computing device. The computing device comprises interface circuitry and processing circuitry communicatively coupled to the interface circuitry. The interface circuitry is configured to provide access to a full schema of a non-relational database. The processing circuitry is configured to identify a table of a relational database from a relational database query that references the table, provisionally update the full schema of the non-relational database with a partial schema that describes the table pending evaluation of the full schema, and accept or reject the provisional update of the full schema according to the partial schema responsive to the evaluation of the full schema.

Yet other embodiments include a non-transitory computer readable medium storing a computer program product for controlling a programmable computing device. The computer program product comprises software instructions that are executable to cause the programmable computing device to identify a table of a relational database from a relational database query that references the table, provisionally update a full schema of a non-relational database with a partial schema that describes the table pending evaluation of the full schema, and accept or reject the provisional updating of the full schema according to the partial schema responsive to the evaluation of the full schema.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter generally, whereas discussion of a specific instance of an illustrated element will append a letter designation thereto (e.g., discussion of a query 220, generally, as opposed to discussion of particular instances of queries 220a, 220b).

FIG. 1 is a block diagram illustrating an example computing device according to one or more embodiments of the present disclosure.

FIG. 2 is a block diagram illustrating an example of updating a full database schema using partial schema according to one or more embodiments of the present disclosure.

FIG. 3 is a block diagram illustrating identification selecting a query based on execution frequency according to one or more embodiments of the present disclosure.

FIG. 4A is a table illustrating an example schema based on separate collections according to one or more embodiments of the present disclosure.

FIG. 4B is a table illustrating an example schema based on document embedding according to one or more embodiments of the present disclosure.

FIG. 5 is a block diagram illustrating an example of identifying a partial schema according to one or more embodiments of the present disclosure.

FIG. 6 is a flow diagram illustrating an example method according to one or more embodiments of the present disclosure.

FIG. 7 is a flow diagram illustrating a more detailed example method according to one or more embodiments of the present disclosure.

FIG. 8 is a block diagram illustrating example hardware of a computing device according to one or more embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For clarity in understanding the disclosure below, to the extent that “one of” a conjunctive list of items (e.g., “one of A and B”) is discussed, the present disclosure refers to one (but not both) of the items in the list (e.g., an A or a B, but not both A and B). Such a phrase does not refer to one of each of the list items (e.g., one A and one B), nor does such a phrase refer to only one of a single item in the list (e.g., only one A, or only one B). Similarly, to the extent that “at least one of” a conjunctive list of items is discussed (and similarly for “one or more of” such a list), the present disclosure refers to any item in the list or any combination of the items in the list (e.g., an A only, a B only, or both an A and a B). Such a phrase does not refer to at least one of each of the items in the list (e.g., at least one of A and at least one of B).

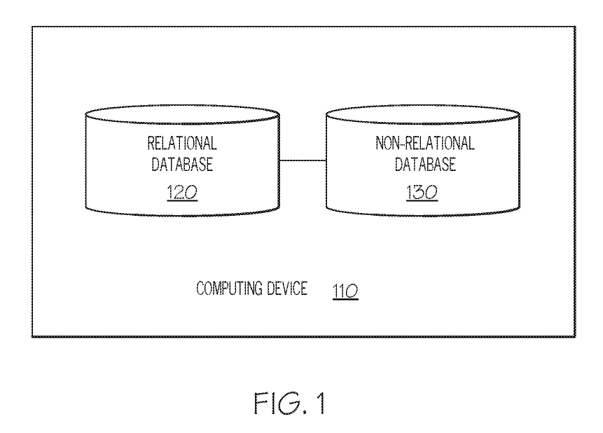

Turning to the figures, FIG. 1 illustrates an example computing device 110. The computing device 110 comprises a relational database 120 and a non-relational database 130. As will be discussed in further detail below, the relational database 120 comprises one or more tables of information that, according to embodiments, may be imported into the non-relational database 130. According to this example, the computing device 110 comprises memory circuitry (not shown) capable of storing the relational database 120 and non-relational database 130, as well as interface circuitry (not shown) by which information may be exchanged between the relational database 120 and non-relational database 130. Further details on the hardware comprised within the computing device will be discussed in further detail below.

Typical examples of the computing device 110 include a personal computer, a laptop computer, a desktop computer, a workstation, a smartphone, a tablet computer, a wearable computer, a smart appliance, a server computer, a server cluster, network attached storage, and/or a storage area network. Although the example of FIG. 1 illustrates the relational database 120 and non-relational database 130 within the computing device 110, according to other embodiments, one or both of the databases 120, 130 may be stored remotely from the computing device 110 (e.g., at a different computing device) and accessed via a network (not shown).

In some embodiments, the non-relational database 130 is intended to perform some or all of the functions of the relational database 120 using a design that is different therefrom. For example, the relational database 120 may be performing poorly due to an overly-complex schema that has not scaled well over time, and the non-relational database 130 is intended to provide similar access to the information of the relational database 120 with improved performance. As such, a schema of the non-relational database may be generated and/or updated to describe tables from the relational database 120.

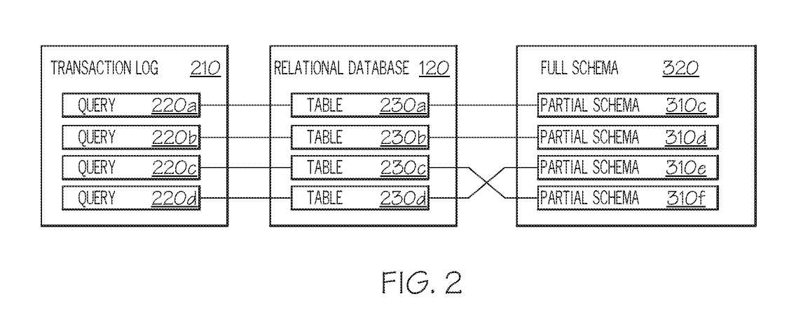

An example of updating a full schema 320 of a non-relational database 130 using partial schema 310c-f describing tables 230a-d (respectively) is illustrated in FIG. 2. The tables 230a-d are identified from queries 220a-d, respectively, which are stored in a transaction log 210 that comprises a history of queries 220a-d previously executed against the relational database 120. As will be discussed further below, the updating of the full schema 320 with a partial schema 310 may be provisional, pending evaluation of the full schema 320 (e.g., via performance testing of the non-relational database 130).

According to the example embodiment illustrated in FIG. 2, the relational database 120 comprises four tables 230a-d, though other embodiments may include more or fewer tables 230. Information in one or more of the tables 230a-d may be used and/or retrieved from the relational database 120 using one or more queries 220a-d. The relational database 120 may, in particular, support Structured Query Language (SQL) queries, any or all of which may refer to one, some, or all of the tables 230a-d in the relational database 120, according to various embodiments. Although the example of FIG. 2 illustrates a one-to-one relationship between queries 220a-d and tables 230a-d, other embodiments may include a query 220 that refers to more than one table 230. Additionally or alternatively, embodiments may include a table 230 that is referenced by more than one query 220.

As one such example consistent with the above and the illustration of FIG. 2, table 230a may be named “manager,” and query 220a may be configured to retrieve all of the records from table 230a according to the SQL string “select * from manager.” Other examples of the relational database 120 may support other types of queries 220.

As previously mentioned, the previous execution of queries 220a-d against the relational database 120 is recorded in transaction log 210. For example, each line of the transaction log 210 may indicate an instance of a query 220 previously executed against the relational database 120. Along with each query 220 may also be included, e.g., a timestamp of when the query 220 was executed, the literal query string used, a query start time, a query end time, and/or an execution duration. The transaction log 210 may be stored on the computing device 120 and/or on a remote computer device, according to particular embodiments.

Although each of the queries 220a-d is illustrated only once in the transaction log 210 illustrated in FIG. 2, each query 220a-d in the transaction log 210 may occur more than once according to embodiments. For example, in an embodiment in which query 220a has historically been executed against the relational database 120 fifty times, query 220a may occur fifty times within the transaction log 210. Other embodiments may include a query 220 that occurs in the transaction log 210 less frequently than it has been historically executed against the relational database 120. For example, the transaction log 210 may be configured to discard information is older than a threshold.

Embodiments of the present disclosure update the full schema 320 with partial schemas 310c-f to describe tables 230a-d, respectively, in a manner that is compatible with the non-relational database 130. In some embodiments, updating the full schema 320 with partial schemas 310c-f allows for data in the relational database 120 corresponding to tables 230a-d to be exported from the relational database 120 and imported into the non-relational database 130.

In some embodiments, the computing device 110 may update the full schema 320 by iterating through each of the queries 220a-d to select a corresponding partial schema 310c-f that describes the tables 230a-d referenced by those queries 220a-d. According to other embodiments, the computing device 110 the computing device 110 iterates through fewer than all of the queries 220a-d and/or skips one or more tables 230a-d, based on particular criteria. Such criteria may be specified by a user of the computing device 110, for example. In some embodiments, the computing device 110 may group and/or prioritize the tables 230a-d used for updating the full schema 320, for example, based on a frequency in which one or more corresponding queries have historically been executed against the relational database 120.

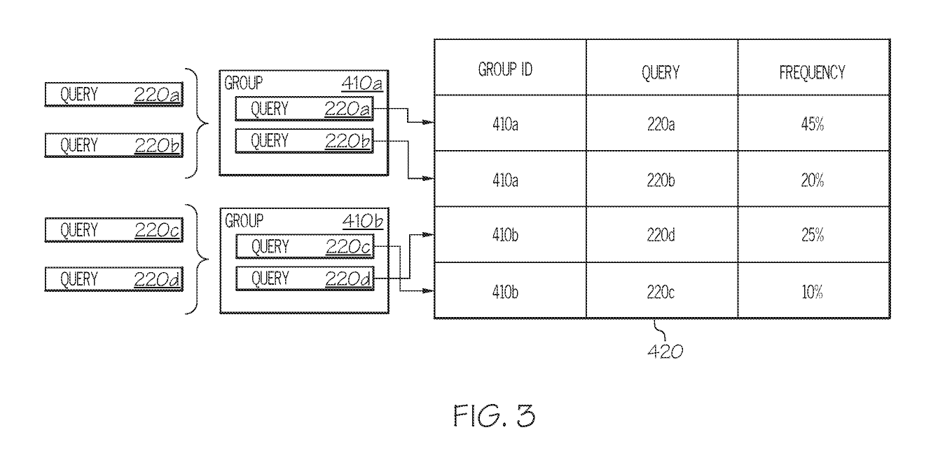

FIG. 3 illustrates an example in which the tables 220a-d are prioritized for use in updating a full schema 320 of the non-relational database 130 based on their corresponding query execution history. According to this example, the queries 220a-d are grouped into different groups 410a-b, e.g., to ensure that particular types of queries 220 are processed consecutively. The queries 220a-b, 220c-d in each group 410a, 410b (respectively) are sorted based on the frequency in which each query 220a-d has been historically executed against the relational database 120 (e.g., as indicated in the transaction log 210) from most-frequent to least-frequent to ensure that more-frequently executed queries 220 are processed before less-frequently executed queries 220 within the same group 410.

In particular, the computing device 110 may group the queries 220a-d according to different criteria, according to various embodiments. For example, the computing device 110 may group queries 220 into groups 410 according to which queries 220 tend to execute contemporaneously. Additionally or alternatively, the computing device 110 may group queries 220 into groups 410 based on which queries 220 have a similar execution frequency. Further embodiments may include grouping queries 220 based on the time of day in which have historically executed and/or which table(s) 230 of the relational database 120 they reference. Other embodiments may include other criteria for grouping queries 220.

In this particular example, the computing device 110 groups query 220a with query 220b into group 410a, and groups query 220c with query 220d into group 410b, e.g., according to one or more of the criteria discussed above. The queries 220a-b, 220c-d in each group 410a, 410b (respectively) are then sorted. In this example, the queries 220a-b, 220c-d are sorted according to their execution frequency, from highest to lowest, as determined from the relative number of times each is listed in the transaction log 210.

According to this example, the transaction log 210 indicates that query 220a has an execution frequency of 45% (i.e., 45% of the queries 220 in the transaction log are instances of query 220a) and query 220b has an execution frequency of 20%. Accordingly, query 220a (having the highest frequency within group 410a) is arranged to be first within group 410a, followed by query 220b. Queries 220c-d have execution frequencies of 10% and 25%, respectively. Accordingly, query 220d (having the highest frequency within group 410b) is arranged to be first within group 410b, followed by query 220c.

The groups 410a-b are then sorted according to which group 410 has the highest-frequency query 220. In this example, since the highest-frequency query 220a in group 410a (with a frequency of 45%) is greater than the highest-frequency query 220d in group 410b (with a frequency of 25%), the queries 220a-b of group 410a are prioritized ahead of the queries 220c-d of group 410b. The resulting prioritization order of query 220a, 220b, 220d, 220c (from highest to lowest priority) is reflected in the priority table 420. The computing device 110 may then identify corresponding tables 230a, 230b, 230d, and 230c (e.g., one at a time in accordance with this prioritization order) to select corresponding partial schemas 310c, 310d, 310e, 310f respectfully that will be used to update the full schema 320.

As previously mentioned, the full schema 320 may be provisionally updated pending an evaluation thereof. In particular, the performance of the non-relational database 130 may differ depending on the partial schema 310 used to describe the tables 230a-d.

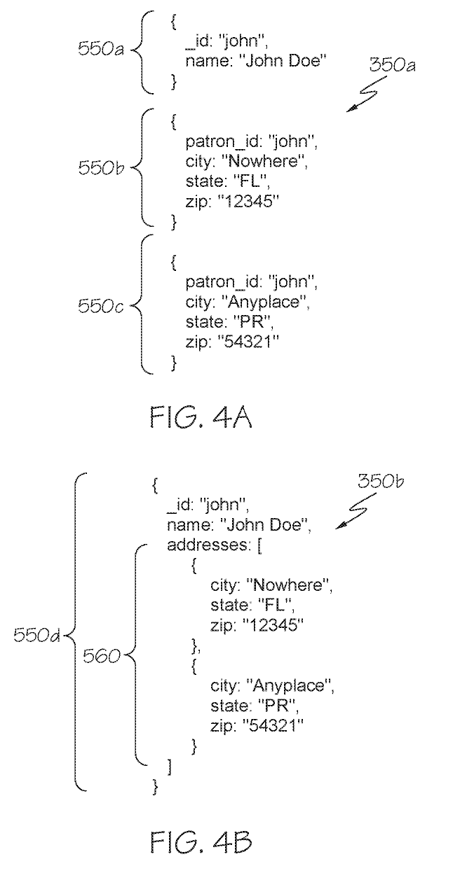

For example, FIG. 4A illustrates an example schema 350a for a simple address book based on separate collections 550a-c written in JavaScript Object Notation (JSON). Collection 550a includes a name/value pair that specifies a contact's name, while collections 550b-c each specify addresses corresponding to the contact in collection 550a. As shown in FIG. 4A, collection 550a has an “_id” name/value pair that is referenced by the “patron_id” name/value pairs in collections 550b-c, which indicates that these addresses of collections 550b-c correspond to the contact of collection 550a. According to this example schema 350a, in order to retrieve an address, some embodiments may be required to use multiple database queries to resolve the references between the separate collections 550a-c.

FIG. 4B illustrates a different example schema 350b for the same simple address book of FIG. 4A, except based instead on document embedding. As shown in FIG. 4B, example schema 350b comprises a single collection 550d. This collection 550d contains an embedded document 560 to describe the address data that was structured according to separate collections 550b-c in example schema 310a. According to this example schema 350a, and in some embodiments, address data may be retrieved using a single database query.

The example schemas 350a-b may have different advantages and/or disadvantages depending on various implementation-specific factors. Further, the example schemas 350a-b may be partial schemas that may be incorporated into a larger schema. For example, the example schema 350b may be incorporated into a larger schema such that the address information of a client in the example schema 350b may be matched to that client's business transactions in the larger schema.

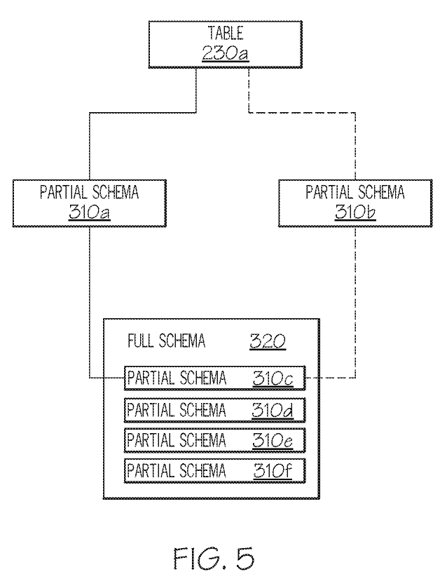

For example, as illustrated in FIG. 5, the non-relational database 130 may be structured according to a full schema 320 that already comprises partial schemas 310d-e, but does not yet comprise partial schema 310c, which will describe table 230a in a manner compatible with the full schema 320 of the non-relational database 130. Partial schema 310a and partial schema 310b may be candidates for use as the partial schema 310c pending a performance evaluation of the non-relational database 130 using whichever of partial schema 310a or 310b is selected. For example, partial schema 310a may by based on document embedding, whereas partial schema 310b may be based on separate collections, either of which may be used to describe table 230a as part of the full schema 320.

According to this particular example, the computing device 110 provisionally updates the full schema 320 according to partial schema 310a. Accordingly, partial schema 310a is provisionally used as partial schema 310c within the full schema 320 to describe table 230a within the non-relational database 130. The computing device 110 then translates the query 220a (used to identify table 230a) into a non-relational translation thereof. The computing device 110 then determines an execution duration of the translation by executing the translation against the non-relational database 130. Based on this execution duration, the computing device 110 may accept or reject the provisional updating of full schema 320 according to partial schema 310a. For example, if the translation of query 220a does not execute more quickly than the query 220a itself, the computing device 110 may reject using partial schema 310a as partial schema 310c in the full schema 320 (e.g., by discarding the changes made to the full schema 320).

Accordingly, the computing device 110 may, e.g., accept or reject provisionally updating the full schema 320 according to partial schema 310a based on whether the execution duration of the translation is shorter or longer, respectively, than a baseline execution duration. In some embodiments, this baseline execution duration may be determined based on previous execution of query 220a against the relational database 120. For example, the transaction log 210 may include an execution duration (or starting and ending execution times) for each time query 220a was executed against the relational database 120. The computing device 110 may use this historical information in the transaction log 210 to determine, for example, an average execution duration for the query 220a.

Other embodiments may use other criteria as a baseline execution duration. For example, the computing device 110 may set a threshold as a maximum allowable (or preferred) execution duration. Other embodiments may use other criteria to accept or reject provisionally updating the full schema 320 according to the partial schema 310a.

If the computing device 110 rejects the provisional update of full schema 320 according to partial schema 310a, the computing device 110 may provisionally update the full schema 320 using a different partial schema 310b (i.e., thereby replacing partial schema 310a as the partial schema 310c within the full schema 320). The computing device 110 may then evaluate the performance of the non-relational database 130 using the different partial schema 310b as the partial schema 310c within the full schema 320.

For example, the computing device 110 may first provisionally update the full schema 320 using a partial schema 310a based on separate collections, and responsive to determining that a non-relational translation of query 230a takes longer to execute against the non-relational database 130 than query 230a takes to execute against the relational database 120, the computing device 110 may reject the provisional update of the full schema 320 using the separate collection-based partial schema 310a. Responsive to this rejection, the computing device 110 may provisionally update the full schema 320 using a partial schema 310b based on document embedding, which may improve (or worsen) the performance results.

Although the example illustrated in FIG. 5 includes two partial schemas 310a-b that are available to the computing device 110 as candidates for updating the full schema 320, other embodiments may including fewer, additional, or different partial schemas 310. Further, although particular embodiments described above relate specifically to partial schemas 310 used to describe table 230a, other embodiments may be similarly used to update the full schema 320 with partial schemas 310 describing other tables 230.

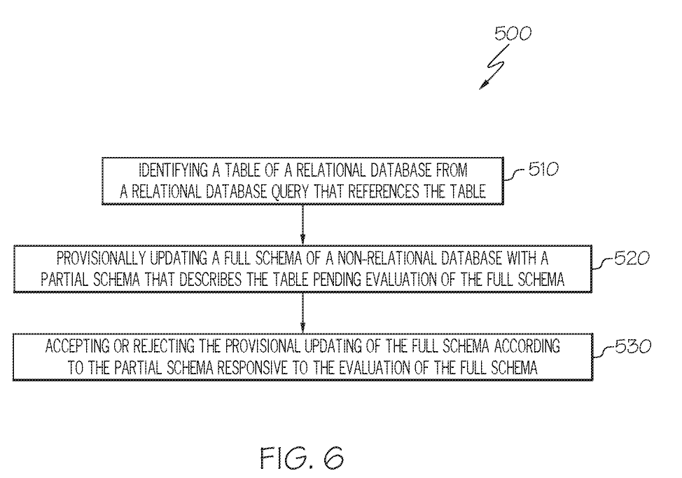

Consistent with the above, FIG. 6 illustrates an example method 500 implemented by a computing device 110, according to one or more embodiments of the present disclosure. The example method 500 comprises identifying a table 230a of a relational database 120 from a relational database query 220a that references the table 230a (block 510). The example method 500 further comprises provisionally updating a full schema 320 of a non-relational database 130 with a partial schema 310a that describes the table 230a pending evaluation of the full schema 320 (block 520). The example method 500 further comprises accepting or rejecting the provisional updating of the full schema 320 according to the partial schema 310a responsive to the evaluation of the full schema 320 (block 530).

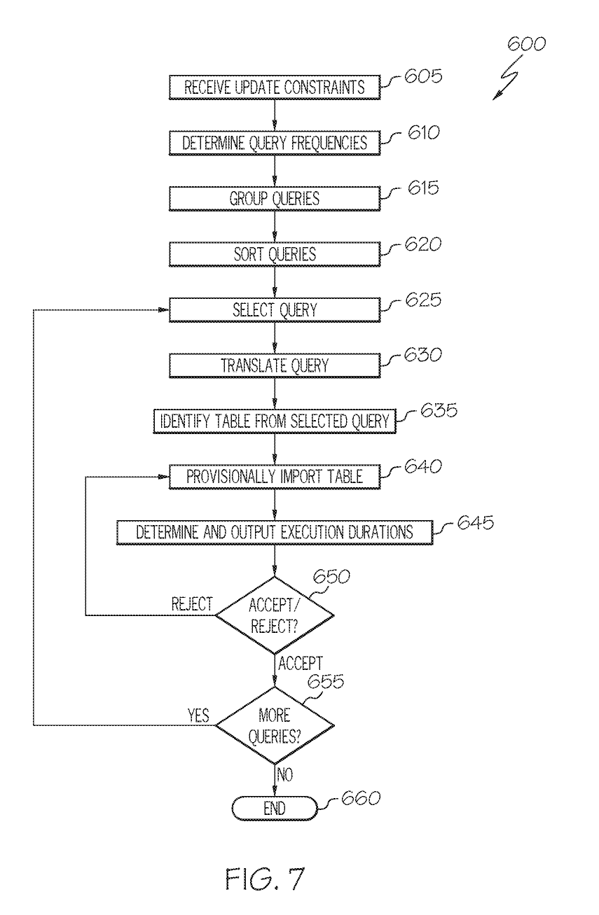

FIG. 7 illustrates a more detailed example method 600 implemented by a computing device 110, according to one or more embodiments of the present disclosure. According to the more detailed example method 600, the computing device 110 may receive update constraints, e.g., from user input (block 605). The update constraints may indicate one or more criterion for filtering out queries 220 and/or tables 230 from being used for updating the full schema 320. For example, the update constraints may specify a frequency threshold that a query 220 must meet in order for a table 230 corresponding to that query 220 to be considered for updating the full schema 320. As one such example, the update constraints may specify that a query 220 must have occurred at least fifty times and/or constitute at least 10% of the queries 220 in the transaction log 210 in order for its corresponding table(s) 230 to be considered for updating the full schema 320. The update constraints may additionally or alternatively specify a timeframe in which a query 220 must have been executed in order to a table 230 corresponding to that query 220 to be considered by the computing device 110 for updating the full schema 320. For example, the update constraints may specify that a query 220 must have occurred within the last month in order for its corresponding table(s) 230 to be considered for updating the full schema 320.

The computing device 110 may then read the transaction log 210 of the relational database 120 to determine how frequently each of the queries 220a-d listed in the transaction log 210 has historically been executed against the relational database 120 (block 610). The computing device 110 may then group the queries 220a-d that meet the update constraints into different groups 410a-b (block 615), and sort the queries 220a-b, 220c-d in each group 410a-b according to the determined frequencies (e.g., in order of most-frequently executed to least-frequently executed) (block 620). The computing device 110 may then select a query 220a from the groups 410a-b of queries 220a-d based on the determined frequencies (block 625). For example, the computing device 110 may initially select the most-frequently executed query 220a.

The computing device 110 may translate the selected query 220a (which was previously executed against the relational database 120) into a non-relational translation (e.g., for use in evaluating the performance of full schema 320) (block 630). The computing device 110 may also identify a table 230a of the relational database 120 from the selected query 220a (block 635). For example, responsive to the selected query 220a using the literal string “select * from manager,” the computing device 110 may identify a table 230a in the relational database 120 that is addressable by the label “manager.”

Responsive to the table 230a being identified, the computing device 110 may provisionally update the full schema 320 with a partial schema 310a that describes the table 230a pending the evaluation of the full schema 320 (block 640). In particular, the computing device 110 may select a partial schema 310a that is based on document embedding or based on separate collections, according to one or more embodiments.

To evaluate the performance of the non-relational database 130, the computing device 110 may determine an execution duration for the query 220a and an execution duration for the translation of the query 220a (block 645). In particular, the computing device 110 may determine an execution duration that serves as a baseline based on previous execution of the relational database query 220a against the relational database 120 (e.g., as indicated in the transaction log 210). The computing device 110 may also determine an execution duration of executing the non-relational translation of the relational database query 220a against the non-relational database 130. The computing device 110 may then output these execution durations to a display.

The computing device 110 may accept or reject the provisional updating of the full schema 320 according to the partial schema 310a (block 650). In some embodiments, accepting or rejecting the provisional updating of the full schema 320 according to the partial schema 310a may be based on user input received in response to outputting the execution durations to the display (i.e., a user may designate whether to accept or reject the provisional updating based on the execution durations). According to other embodiments, the computing device 110 may be configured to accept or reject based on preconfigured criteria. For example, the computing device 110 may be configured to accept the provisional updating according to the partial schema 310a unless the execution duration of the translation is longer than the baseline execution duration of the query 220a determined from historical data in the transaction log 210.

Responsive to the computing device 110 rejecting the provisional updating of the full schema 320 according to the partial schema 310a (block 650, reject), the computing device 110 may provisionally update the full schema 320 according to a different partial schema 310b (block 640) for reevaluation of the full schema 320. Accordingly, the computing device 110 may determine a new execution duration of the query translation by executing the query translation against the non-relational database 130 using the full schema 320 as provisionally updated with the different partial schema 310b (block 645). The computing device 110 may then accept or reject the provisional update of the full schema 320 according to the different partial schema 310b responsive to this further evaluation of performance (block 650).

Responsive to the computing device 110 accepting the provisional updating of the full schema 320 (block 650, accept), the computing device 110 may determine if there are other queries 220 to be processed (block 655). If so (block 655, yes), the computing device 110 may select a different query 220b (block 625) and proceed as described above. If not (block 655, no), the more detailed example method 600 may end (block 660).

Other embodiments include methods that perform similar processing to that described above according to a different ordering than that depicted in FIG. 7. For example, some embodiments may include determining execution frequencies for the queries 220 identified by reading the relational database 120 transaction log 210, followed by grouping the related queries 220 and/or tables 230, then subsequently determining their execution durations against the relational database 120, followed by sorting the queries 220 of each group 410, and then receiving update constraints for filtering the queries 220 and/or tables 230 (e.g., as in block 605). Other embodiments include other ordering of particular processing features described above.

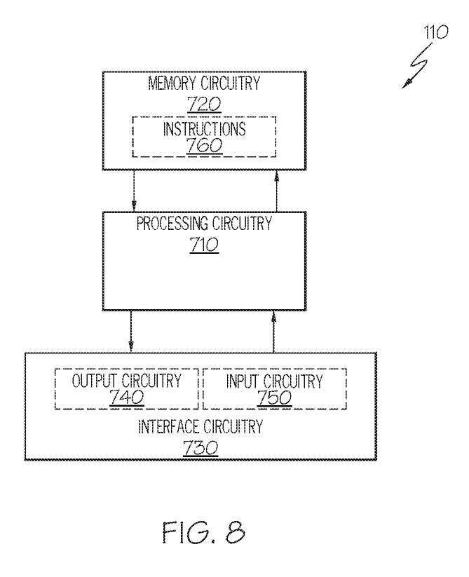

Other embodiments of the present disclosure include the computing device 110 implemented according to the hardware illustrated in FIG. 8. The example hardware of FIG. 8 comprises processing circuitry 710, memory circuitry 720, and interface circuitry 730. The processing circuitry 710 is communicatively coupled to the memory circuitry 720 and the interface circuitry 730, e.g., via one or more buses. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions stored as a machine-readable computer program 760 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the computing device 110. Such I/O data paths may include data paths for exchanging signals over a communications network and data paths for exchanging signals with a user. For example, the interface circuitry 730 may comprise a transceiver configured to send and receive communication signals over one or more of a wireless network, Ethernet network, and/or optical network. The interface circuitry 730 may also comprise one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 730 may also comprise one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 730 may be implemented as a unitary physical component, or as a plurality of physical components that are contiguously or separately arranged, any of which may be communicatively coupled to any other, or may communicate with any other via the processing circuitry 710. For example, the interface circuitry 730 may comprise output circuitry 740 (e.g., transmitter circuitry configured to send communication signals over the communications network) and input circuitry 750 (e.g., receiver circuitry configured to receive communication signals over the communications network). Similarly, the output circuitry 740 may comprise a display, whereas the input circuitry 750 may comprise a keyboard. Other examples, permutations, and arrangements of the above and their equivalents will be readily apparent to those of ordinary skill.

According to embodiments of the hardware illustrated in FIG. 8, the interface circuitry 730 is configured to provide access to a full schema 320 of a non-relational database 130. The processing circuitry 710 is configured to identify a table 230a of a relational database 120 from a relational database query 220a that references the table 230a. The processing circuitry 710 is further configured to provisionally update the full schema 320 of the non-relational database 130 with a partial schema 310a that describes the table 230a pending evaluation of the full schema 320. The processing circuitry 710 is further configured to accept or reject the provisional updating of the full schema 320 according to the partial schema 310a responsive to the evaluation of the full schema 320.

Other embodiments of the present disclosure include a non-transitory computer readable medium (e.g., the memory circuitry 720 and/or other physical medium) comprising software instructions 760. Such software instructions 760 may be executable by a programmable computing device 110 (e.g., by loading such instructions 760 into memory circuitry 720 for subsequent execution by processing circuitry 710) to cause the programmable computing device 110 to identify a table 230a of a relational database 120 from a relational database query 220a that references the table 230a. The processing circuitry 710 is further configured to provisionally update the full schema 320 of the non-relational database 130 with a partial schema 310a that describes the table 230a pending evaluation of the full schema 320. The processing circuitry 710 is further configured to accept or reject the provisional updating of the full schema 320 according to the partial schema 310a responsive to the evaluation of the full schema 320.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A computer-implemented method comprising:
identifying a table of a relational database from a relational database query that references the table;
provisionally updating a full schema of a non-relational database with a partial schema that describes the table pending evaluation of the full schema;
accepting or rejecting the provisional updating of the full schema according to the partial schema responsive to the evaluation of the full schema.

2. The method of claim 1, wherein the evaluation of the full schema comprises:
determining an execution duration of executing a non-relational translation of the relational database query against the non-relational database using the full schema;
determining a baseline execution duration based on previous execution of the relational database query against the relational database.

3. The method of claim 2, wherein accepting or rejecting the provisional updating of the full schema according to the partial schema is based on user input received in response to outputting the execution duration and baseline execution duration to a display.

4. The method of claim 2, further comprising translating the relational database query into the non-relational translation of the relational database query.

5. The method of claim 1, wherein accepting or rejecting the provisional updating of the full schema according to the partial schema comprises rejecting the provisional updating of the full schema according to the partial schema, and the method further comprising, in response:
provisionally updating the full schema with a different partial schema that describes the table pending reevaluation of the full schema;
accepting or rejecting the provisional updating of the full schema according to the different partial schema responsive to the reevaluation of the full schema.

6. The method of claim 5, wherein one of the partial schema or different partial schema is based on document embedding and the other of the partial schema or different partial schema is based on separate collections.

7. The method of claim 1, wherein identifying the table of the relational database from the relational database query comprises selecting the relational database query based on a frequency in which the relational database query has historically been executed against the relational database.

8. The method of claim 7, wherein selecting the relational database query based on the frequency in which the relational database query has historically been executed against the relational database comprises selecting the relational database query based on the frequency exceeding a user-specified threshold within a user-specified timeframe.

9. The method of claim 7, further comprising, subsequent to the accepting or rejecting of the provisional updating of the full schema according to the partial schema, further provisionally updating the full schema with a different partial schema that describes a further table of the relational database identified by:
grouping a plurality of relational database queries into different groups, wherein a given group comprises the relational database query that references the table and a further relational database query that references the further table;
selecting the further relational database query based on the further relational database query being in the given group with the relational database query and having a next-highest frequency of historically being executed against the relational database relative to the relational database query;
responsive to selecting the further relational database query, identifying the further table from the further relational database query.

10. A computing device comprising:
interface circuitry configured to provide access to a full schema of a non-relational database;
processing circuitry communicatively coupled to the interface circuitry and configured to:
identify a table of a relational database from a relational database query that references the table;
provisionally update the full schema of the non-relational database with a partial schema that describes the table pending evaluation of the full schema;
accept or reject the provisional update of the full schema according to the partial schema responsive to the evaluation of the full schema.

11. The computing device of claim 10, wherein to evaluate the full schema the processing circuitry is configured to:
determine an execution duration of executing a non-relational translation of the relational database query against the non-relational database using the full schema;
determine a baseline execution duration based on previous execution of the relational database query against the relational database.

12. The computing device of claim 11, wherein to accept or reject the provisional update of the full schema according to the partial schema the processing circuitry is configured to accept or reject the provisional update based on user input received in response to outputting the execution duration and baseline execution duration to a display.

13. The computing device of claim 11, wherein the processing circuitry is further configured to translate the relational database query into the non-relational translation of the relational database query.

14. The computing device of claim 10, wherein to accept or reject the provisional update of the full schema according to the partial schema the processing circuitry is configured to reject the provisional update of the full schema according to the partial schema, and the processing circuitry is further configured to, in response:
provisionally update the full schema with a different partial schema that describes the table pending reevaluation of the full schema;
accept or reject the provisional update of the full schema according to the different partial schema responsive to the reevaluation of the full schema.

15. The computing device of claim 14, wherein one of the partial schema or different partial schema is based on document embedding and the other of the partial schema or different partial schema is based on separate collections.

16. The computing device of claim 10, wherein to identify the table of the relational database from the relational database query the processing circuitry is configured to select the relational database query based on a frequency in which the relational database query has historically been executed against the relational database.

17. The computing device of claim 16, wherein to select the relational database query based on the frequency in which the relational database query has historically been executed against the relational database the processing circuitry is configured to select the relational database query based on the frequency exceeding a user-specified threshold within a user-specified timeframe.

18. The computing device of claim 16, wherein the processing circuitry is further configured to, subsequent to the accepting or rejecting of the provisional update of the full schema according to the partial schema, further provisionally update the full schema with a different partial schema that describes a further table of the relational database identified by:
grouping a plurality of relational database queries into different groups, wherein a given group comprises the relational database query that references the table and a further relational database query that references the further table;
selecting the further relational database query based on the further relational database query being in the given group with the relational database query and having a next-highest frequency of historically being executed against the relational database relative to the relational database query;
responsive to selecting the further relational database query, identifying the further table from the further relational database query.

19. A non-transitory computer readable medium storing a computer program product for controlling a programmable computing device, the computer program product comprising software instructions that are executable to cause the programmable computing device to:
identify a table of a relational database from a relational database query that references the table;
provisionally update a full schema of a non-relational database with a partial schema that describes the table pending evaluation of the full schema;
accept or reject the provisional updating of the full schema according to the partial schema responsive to the evaluation of the full schema.
